(19) United States
(12) Patent Application Publication
(10) Pub. No.: US 2020/0029376 A1
(43) Pub. Date: Jan. 23, 2020

(54) SELECTIVE RETRANSMISSION PROCEDURE

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US)

(21) Appl. No.: 16/421,093

(22) Filed: May 23, 2019

Related U.S. Application Data
(60) Provisional application No. 62/702,885, filed on Jul. 24, 2018.
(60) Provisional application No. 62/700,842, filed on Jul. 19, 2018.

(51) Int. Cl. H04W 76/14; H04W 28/04; H04L 1/00

(52) U.S. Cl. CPC H04W 76/14; H04W 84/12; H04L 1/0061; H04W 28/04

(57) ABSTRACT

This disclosure provides systems, devices, apparatus and methods, including computer programs encoded on storage media, for an access point (AP) and a station. In one aspect, the AP can transmit a first trigger frame to the station. The AP may receive a packet from the station including one or more information units, an identifier of the information units, and a wireless device identifier. The AP can determine at least one information unit to be retransmitted by the station and transmit a second trigger frame identifying the information unit. In some aspects, the AP can determine a proxy arrangement with a proxy AP that can transmit the second trigger frame. In some aspects, the AP can transmit the first trigger frame to multiple stations and determine an information unit to be retransmitted based on a tunneled direct link setup (TDLS) link.

### CROSS REFERENCE TO RELATED APPLICATIONS

This application claims the benefit of U.S. Provisional Application Ser. No. 62/702,885, entitled “SELECTIVE RETRANSMISSION PROCEDURE” and filed on Jul. 24, 2018, and U.S. Provisional Application Ser. No. 62/700,842, entitled “SELECTIVE RETRANSMISSION PROCEDURE” and filed on Jul. 19, 2018, each of which are expressly incorporated by reference herein in their entirety.

### TECHNICAL FIELD

This disclosure generally relates to wireless communications.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish or maintain a communication link with the WLAN.

Some aspects of WLAN communications can provide for multi-user transmissions in either the uplink (UL) or downlink (DL) directions. For example, UL multi-user (MU) multiple-input, multiple-output (MIMO) or MU orthogonal frequency division multiple access (OFDMA) techniques can be utilized. These types of communications enable the STAs to send UL data in response to a provocation from an AP, such as a trigger frame. When a trigger frame is sent by an AP, it can solicit a recipient STA(s) to transmit UL data in response. Such a response can be formatted as a trigger-based (TB) physical layer convergence procedure (PLCP) protocol data unit (PDU), also referred to as a TB PPDU. Such a response also can be in an aggregated medium access control (MAC) PDU (A-MPDU) format containing multiple MPDUs including Quality of Service (QoS) data frames. Each MPDU can be addressed to the AP transmitting the trigger frame. In turn, the AP can recommend transmission information to the recipient STA(s), such as which access class (AC) can be used for the QoS data frames and the number of traffic identifiers (TIDs) from which the QoS data frames can be selected.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method can include a first wireless device transmitting a first trigger frame to one or more second wireless devices. The first wireless device may receive a packet from at least one second wireless device including one or more information units. The packet can also include at least one identifier of the information units and at least one wireless device identifier. The first wireless device can also determine, based on the at least one wireless device identifier and the at least one identifier of the information units, at least one of the one or more information units to be retransmitted by the at least one second wireless device. In some aspects, the first wireless device can also determine one or more information units not to be retransmitted by the at least one second wireless device. The retransmission may be needed if at least a portion of the information unit is received as corrupted. Further, the first wireless device can transmit a second trigger frame, after receiving the packet, to the at least one second wireless device that identifies the at least one information unit to be retransmitted. In certain embodiments, the first wireless device may determine the portion of the one or more information units to be retransmitted.

Another innovative aspect of the subject matter described in this disclosure can be implemented in a method for wireless communication. In some implementations, the method can include a first wireless device receiving a first trigger frame from a second wireless device. The first wireless device may transmit a packet to the second wireless device. The packet can include one or more information units, at least one identifier of the information units, and at least one wireless device identifier. Additionally, the first wireless device may receive a second trigger frame from the second wireless device that identifies at least one of the one or more information units to be retransmitted. The first wireless device may also transmit, to the second wireless device, the at least one information unit identified by the second trigger frame to be retransmitted.

Another innovative aspect of the subject matter described in this disclosure can be implemented in a wireless communication device at a first wireless device. In some implementations, the wireless communication device includes at least one processor and at least one memory communicatively coupled with the at least one processor and storing processor-readable code that, when executed by the at least one processor, causes the wireless communication device to transmit a first trigger frame to one or more second wireless devices. The wireless communication device can also receive a packet from at least one second wireless device. The packet can include one or more information units. The packet can also include at least one identifier of the information units and at least one wireless device identifier. The wireless communication device can also determine, based on the at least one wireless device identifier and the at least one identifier of the information units, at least one of the one or more information units to be retransmitted by the at least one second wireless device. The retransmission may be needed if at least a portion of the information unit is received as corrupted. The wireless communication device can also transmit a second trigger frame to the at least one second wireless device identifying the at least one information unit to be retransmitted. In certain embodiments, the wireless communication device may determine the portion of the information unit to be retransmitted.

Another innovative aspect of the subject matter described in this disclosure can be implemented in a wireless communication device at a first wireless device. In some implementations, the wireless communication device includes at least one processor and at least one memory communicatively coupled with the at least one processor and storing processor-readable code that, when executed by the at least one processor, causes the wireless communication device to receive a first trigger frame from a second wireless device. The wireless communication device can also transmit a packet to the second wireless device. The packet can include one or more information units, at least one identifier of the information units, and at least one wireless device identifier. Further, the wireless communication device can receive a second trigger frame from the second wireless device identifying at least one of the one or more information units to be retransmitted. The wireless communication device can also transmit, to the second wireless device, the at least one information unit identified by the second trigger frame to be retransmitted.

In some implementations of the methods and wireless communication devices, the at least one wireless device identifier can include at least one of a receiver address (RA) of the first wireless device or a transmitter address (TA) of the at least one second wireless device, wherein determining the at least one information unit to be retransmitted is based on at least one of the TA or the RA.

In some implementations of the methods and wireless communication devices, the one or more information units can correspond to one or more medium access control (MAC) protocol data units (MPDUs), and the at least one identifier of the one or more information units can be at least one of a sequence number (SN), a fragment number (FN), or a traffic identifier (TID).

In some implementations of the methods and wireless communication devices, the second trigger frame can include the SN, or a combination of a starting SN (SSN) and a bitmap of SNs, for the at least one second wireless device to retransmit the at least one information unit.

In some implementations of the methods and wireless communication devices, the packet can include at least one aggregated MPDU (A-MPDU) including the one or more information units.

In some implementations of the methods and wireless communication devices, the packet can include a trigger-based (TB) physical layer convergence procedure (PLCP) protocol data unit (PPDU) that includes the at least one A-MPDU.

In some implementations, the methods and wireless communication devices can be configured to receive the at least one information unit retransmitted from the at least one second wireless device.

In some implementations of the methods and wireless communication devices, transmitting the first trigger frame to the one or more second wireless devices can include broadcasting the first trigger frame to the one or more second wireless devices.

In some implementations of the methods and wireless communication devices, transmitting the second trigger frame to the at least one second wireless device can include broadcasting the second trigger frame to the one or more second wireless devices. In some implementations the second trigger frame may be transmitted in a frequency that is different from the frequency used for transmitting the first trigger frame. Also, the second trigger frame may be transmitted by another entity of the first wireless device that is spatially separated from the entity that transmitted the first trigger frame.

In some implementations of the methods and wireless communication devices, the packet can include at least one MPDU delimiter that precedes the at least one information unit, and determining at least one information unit to be retransmitted can include determining a length of the at least one information unit to be retransmitted by the at least one second wireless device based on information contained in the MPDU delimiter.

In some implementations of the methods and wireless communication devices, determining the at least one information unit to be retransmitted can comprise determining the length of the at least one information unit to be retransmitted if the MPDU delimiter passes a cyclic redundancy check (CRC).

In some implementations of the methods and wireless communication devices, the packet can include a plurality of MPDUs that contain the one or more information units, the packet further including a MAC header and an MPDU delimiter for each of the plurality of MPDUs, wherein at least one of the MAC headers or at least one of the MAC delimiters includes the at least one identifier of the one or more information units and the at least one wireless device identifier.

In some implementations of the methods and wireless communication devices, the packet can include a physical layer (PHY) preamble, the PHY preamble including a signal field that includes at least a portion of the at least one identifier of the one or more information units and the at least one wireless device identifier.

In some implementations, the methods and wireless communication devices can be configured to determine a proxy arrangement with at least one proxy wireless device.

In some implementations of the methods and wireless communication devices, the at least one information unit retransmitted from the at least one second wireless device can be received by the at least one proxy wireless device based on the proxy arrangement, and the methods and wireless communication devices can be configured to receive, from the at least one proxy wireless device, the at least one information unit retransmitted from the at least one second wireless device.

In some implementations, the methods and wireless communication devices can be configured to establish a tunneled direct link setup (TDLS) link between the at least one second wireless device and at least one peer wireless device.

In some implementations of the methods and wireless communication devices, the second trigger frame can be transmitted to solicit the at least one second wireless device to retransmit at least one information unit over the TDLS link with the at least one peer wireless device.

In some implementations, the methods and wireless communication devices may be configured to receive the at least one information unit retransmitted from the at least one second wireless device over the TDLS link.

In some implementations of the methods and wireless communication devices, the at least one information unit retransmitted from the at least one second wireless device can include a receiver address (RA) of the at least one peer wireless device.

In some implementations, the methods and wireless communication devices may be configured to transmit, to the at least one peer wireless device, the at least one information unit retransmitted from the at least one second wireless device.

In some implementations, the methods and wireless communication devices may be configured to transmit at least one acknowledgement (ACK) frame or block ACK (BlockAck) frame to the at least one second wireless device or the at least one peer wireless device over the TDLS link upon reception of the at least one information unit.

In some implementations, the methods and wireless communication devices may be configured to refrain from transmitting the at least one ACK frame or BlockAck frame for the received packet based on selecting to transmit the second trigger frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows an example frame usable for communications between an access point (AP) and a number of stations (STAs).

FIG. 2B shows another example frame usable for communications between an AP and a number of STAs.

FIG. 3 shows a block diagram of an example AP for use in wireless communication.

FIG. 4 shows a block diagram of an example STA for use in wireless communication.

FIG. 5 shows an example of a trigger frame used in communications between an AP and a number of STAs.

FIG. 6 shows an example of communications between an AP and a number of STAs.

FIG. 7A shows a flowchart illustrating an example process 700 for data retransmission according to some implementations.

FIG. 7B shows a flowchart illustrating an example process 750 for data retransmission according to some implementations.

FIG. 8 shows a timing diagram illustrating the transmissions of communications in the example processes of FIGS. 7A and 7B.

FIG. 9 shows a block diagram of an example wireless communication device for use in wireless communication according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (JOT) network.

Various implementations generally relate to identifying data for retransmission in a wireless communication system. Some implementations more specifically relate to an access point (AP) determining and identifying data to be retransmitted by a station (STA). In some implementations, an AP can transmit a first trigger frame to solicit a recipient STA(s) to transmit a packet including UL data in response. After receiving the packet and the UL data from the STA, the AP can identify and determine the UL data to be retransmitted. In some implementations, the AP can transmit a second trigger frame to identify the UL data to be retransmitted by the STA. In some implementations, an AP may refrain from transmitting an ACK frame or a BlockAck frame for the received packet based on selecting to transmit the second trigger frame. For example, because the second trigger frame indicates which UL data is to be retransmitted, an additional ACK or BlockACK is not needed as this information may be provided via the second trigger frame. In some aspects, the second trigger frame can be transmitted within a short interframe space (SIFS) after receiving the packet, within a point coordination function (PCF) interframe space (PIFS) after receiving the packet, or after contending according to an enhanced distributed channel access (EDCA) procedure after receiving the packet.

Some implementations relate to identifying a specific aspect of UL data from the STA, as well as a specific aspect of data to be retransmitted. For instance, in some implementations, the packet received from the STA can include one or more information units, e.g., an aggregated medium access control (MAC) protocol data unit (A-MPDU) that includes multiple aggregated MPDUs, at least one of which includes a Quality of Service (QoS) frame. In some implementations, when the AP determines and identifies the data to be retransmitted, it can determine at least one information unit, e.g., QoS frame, of the multiple information units to be retransmitted by the STA. The retransmission may be needed when at least a portion of the information unit, e.g., QoS frame, is received as corrupted. In some implementations the AP can determine and identify portions of the information unit, e.g., a QoS frame, to be retransmitted (for example only the frame body field of the frame, etc.).

In some aspects, when the subsequent second trigger frame identifies the UL data to be retransmitted, the at least one information unit can be identified. In some implementations, the packet received from the STA can include at least one wireless device identifier, e.g., a medium access control (MAC) address, or at least one identifier of the information units, e.g., sequence numbers (SNs), fragment numbers (FNs), or a traffic identifier (TID). In some implementations, when the AP determines and identifies the data to be retransmitted, it can be based on based on the wireless device identifier or the identifier of the information units. In some implementations, the AP can determine a proxy arrangement with another AP. In some of these instances, the other AP can transmit a trigger frame to a STA identifying the data to be retransmitted. In some implementations, the trigger frame from the other AP can identify at least one information unit, e.g., QoS frame, to be retransmitted. In further implementations, the AP can transmit a trigger frame to multiple STAs. In some of these instances, the trigger frame can determine the data to be retransmitted by one of the STAs. In some instances, the data can be retransmitted to the other STA. In further implementations, the AP and multiple STAs can establish and communicate over a tunneled direct link setup (TDLS) link.

Particular implementations of the subject matter described in this disclosure can be implemented to realize one or more of the following potential advantages. In some implementations, the described techniques can be used to improve the overall throughput of wireless communication systems. In order to improve the throughput of communications, aspects of the present disclosure can utilize multiple APs within an area to instruct a transmitting STA regarding the retransmission of certain data. Some implementations according to the present disclosure can be used to maximize the coverage areas of wireless communication systems. For example, aspects of the present disclosure can maximize coverage areas by utilizing multiple proxy or auxiliary APs. Other implementations according to the present disclosure can be used to improve device communication within the wireless system. Yet other implementations according to the present disclosure can help to conserve data resources. For instance, aspects of the present disclosure can conserve data resources by utilizing an AP to instruct a STA to retransmit data or data frames that were not received.

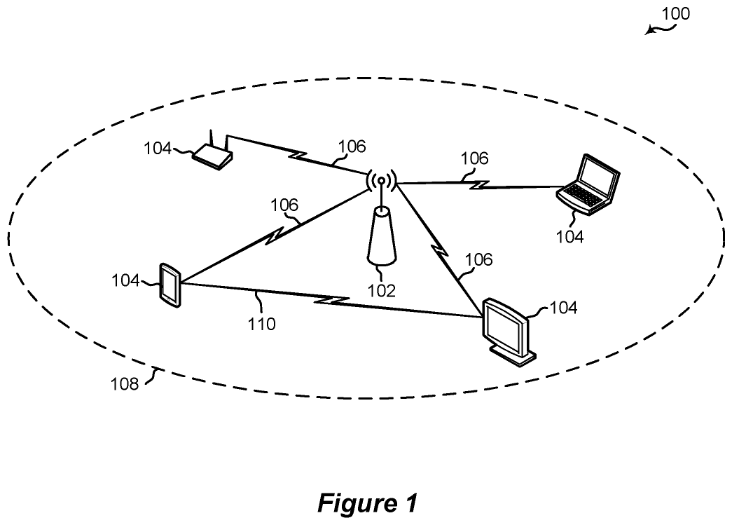

FIG. 1 shows a block diagram of an example wireless communication network 100. One or more devices may be configured to perform one or more techniques described herein. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP. The BSS is identified by a service set identifier (SSID) that is advertised by the AP 102. The AP 102 periodically broadcasts beacon frames (“beacons”) to enable any STAs 104 within wireless range of the AP 102 to establish and/or maintain a respective communication link 106 (hereinafter also referred to as a “Wi-Fi link”) with the AP. The various STAs 104 in the WLAN are able to communicate with external networks as well as with one another via the AP 102 and respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected AP.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA and/or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ay, 802.11ax, 802.11az, and 802.11ba). These standards define the WLAN radio and baseband protocols for the PHY and medium access control (MAC) layers. The APs 102 and STAs 104 transmit and receive frames (hereinafter also referred to as “Wi-Fi communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels. Additionally, in some implementations the AP 102 can transmit PPDUs to multiple STAs 104 simultaneously using one or both of multi user (MU) multiple-input multiple-output (MIMO) (also known as spatial multiplexing) and orthogonal frequency division multiple access (OFDMA) schemes.

Each PPDU typically includes a PLCP preamble, a PLCP header and a MAC header prior to the accompanying data. The information provided in the preamble and headers may be used by a receiving device to decode the subsequent data. A legacy portion of the preamble may include a legacy short training field (STF) (L-STF), a legacy LTF (L-LTF), and a legacy signaling field (L-SIG). The legacy preamble may be used for packet detection, automatic gain control and channel estimation, among other uses. The legacy preamble may also be used to maintain compatibility with legacy devices. In instances in which PPDUs are transmitted over a bonded channel, the L-STF, L-LTF, and L-SIG fields may be duplicated and transmitted in each of the plurality of component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

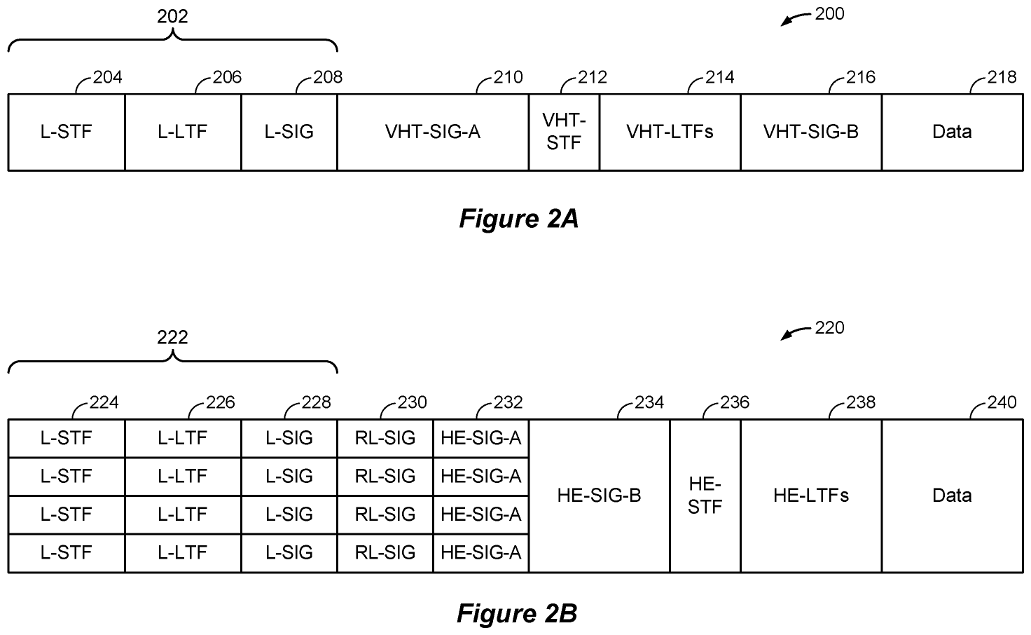

FIG. 2A shows an example frame 200 usable for communications between an AP 102 and each of a number of STAs 104. For example, the frame 200 can be formatted as a very high throughput (VHT) frame in accordance with the IEEE 802.11ac amendment to the IEEE 802.11 standard. The frame 200 includes a legacy preamble portion 202 that includes L-STF 204, L-LTF 206, and L-SIG 208. The frame 200 further includes a non-legacy preamble portion that includes a first very high throughput (VHT) signaling field (VHT-SIG-A) 210, a VHT short training field (VHT-STF) 212, a number of VHT long training fields (VHT-LTFs) 214 and a second VHT signaling field (VHT-SIG-B) 216 encoded separately from the VHT-SIG-A field 210. Like the L-STF 204, L-LTF 206, and L-SIG 208, the information in the VHT-SIG-A field 210 may be duplicated and transmitted in each of the component 20 MHz channels in instances involving the use of a bonded channel. The frame 200 also can include a payload or data field 218 after the preamble. The data field 218 can include medium access control (MAC) protocol data units (MPDUs), for example, in the form of an aggregated MPDU (AMPDU).

The VHT-SIG-A field 210 may indicate to 802.11ac-compatible STAs 104 that the frame 200 is an IEEE 802.11ac frame. The VHT-SIG-A field 210 includes information usable by an identified number of STAs 104 to decode the VHT-SIG-B field 216. The VHT-SIG-A field 210 also may include VHT WLAN signaling information usable by STAs 104 other than the identified number of STAs 104. The VHT-SIG-B field 216 may include VHT WLAN signaling information usable by a subset of the identified number of STAs 104 to decode data received in the data field 218. The number of VHT-LTFs 214 depends on the number of transmitted streams.

FIG. 2B shows another example frame 220 usable for communications between an AP 102 and each of a number of stations 104. For example, the frame 220 can be formatted as a high efficiency (HE) frame in accordance with the IEEE 802.11ax amendment to the IEEE 802.11 standard. The example frame 200 may be used for multi-user (MU) simultaneous transmissions (for example, using multi-user orthogonal frequency division multiple access (MU-OFDMA) or multi-user multiple-input, multiple-output (MU-MIMO) techniques). In some aspects, the frame 200 may be an example of a trigger frame used by the AP 102 to initiate and synchronize uplink (UL) MU-OFDMA or UL MU-MIMO transmissions from the STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID one or more unique resource units (RUs) that can be used to send UL traffic to the AP 102. RUs may be defined in 2 MHz intervals. As such, in a 160 MHz channel, up to 74 RUs (such as 2 MHz, 26-tone RUs) may be allocated. Therefore, it may be possible to schedule as many as 74 STAs 104 for MU OFDMA transmissions. The AP also may designate one or more random access (RA) RUs that unscheduled STAs 104 may contend for. In other aspects, the frame 200 may be an example of a downlink (DL) MU PPDU, such as a DL MU-OFDMA PPDU or a DL MU-MIMO PPDU, used by an AP 102 to send data to multiple STAs 104 simultaneously in corresponding allocated RUs.

The frame 220 includes a legacy preamble portion 222 that includes L-STF 224, L-LTF 226, and L-SIG 228. The frame 220 further includes a non-legacy preamble portion that includes a repeated legacy signaling field (RL-SIG) 230, a first high efficiency signaling field (HE-SIG-A) 232, a second high efficiency signaling field (HE-SIG-B) 234 (encoded separately from the HE-SIG-A field 232), a high efficiency short training field (HE-STF) 236 and a number of high efficiency long training fields (HE-LTFs) 238. The RL-SIG field 230 may indicate to a STA 104 that the frame 220 is an IEEE 802.11ax frame. Like the L-STF 224, L-LTF 226, and L-SIG 228, the information in the RL-SIG field 230 and the HE-SIG-A field 232 may be duplicated and transmitted in each of the component 20 MHz channels in instances involving the use of a bonded channel. The frame 220 also can include a payload or data field 240 after the preamble. The data field 240 can include multiple MPDUs, for example, in the form of AMPDUs.

An AP 102 may use an HE-SIG-A field 232 to indicate to multiple identified STAs 104 that the AP is scheduling UL or DL resources. The HE-SIG-A field 232 may be decoded by each HE-compatible STA 104 served by the AP 102. The HE-SIG-A field 232 includes information usable by the identified STAs 104 to decode associated HE-SIG-B fields 234. For example, the HE-SIG-A field 232 may indicate the frame format, including locations and lengths of HE-SIG-B fields 234, available channel bandwidths, modulation and coding schemes (MCS), among other possibilities. The HE-SIG-A field 232 also may include HE WLAN signaling information usable by STAs 104 other than the number of STAs 104 identified in the frame 200.

The HE-SIG-B fields 234 carry STA-specific scheduling information such as, for example, per-user MCS values and per-user RU allocation information. In the context of DL MU-OFDMA, such information enables the respective STAs 104 to identify and decode corresponding RUs in the data field 240. Each HE-SIG-B field 234 includes a common field and at least one STA-specific (“user-specific”) field. The common field can indicate RU distributions to multiple STAs 104, indicate the RU assignments in the frequency domain, indicate which RUs are allocated for MU-MIMO transmissions and which RUs correspond to MU-OFDMA transmissions, the number of users in allocations, among other possibilities. The common field may be encoded with common bits, cyclic redundancy check (CRC) bits, and tail bits. The user-specific fields are assigned to particular STAs 104 and used to schedule specific RUS and to indicate the scheduling to other WLAN devices. Each user-specific field may include multiple user block fields (which may be followed by padding). Each user block field may include two user fields that contain information for two STAs to decode their respective RU payloads.

The AP 102, as well as some capable STAs 104, may support beamforming. For example, the AP 102 may use multiple antennas or antenna arrays to conduct beamforming operations for directional communications with a STA 104, and vice versa. Beamforming (which may also be referred to as spatial filtering or directional transmission) is a signal processing technique that may be used at a transmitter (for example, AP 102) to shape and/or steer an overall antenna transmission beam in the direction of a target receiver (for example, a STA 104). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 102 may communicate with the STA 104. That is, based on this CSI, the AP 102 may appropriately weight the transmissions from each antenna (for example or antenna port) such that the desired beamforming effects are achieved. In some cases, these weights may be determined before beamforming can be employed. For example, the transmitter (the AP 102) may transmit one or more sounding packets (for example, a null data packet) to the receiver in order to determine CSI.

In some cases, aspects of transmissions may vary based on a distance between a transmitter (for example, AP 102) and a receiver (for example, STA 104). WLAN 100 may otherwise generally benefit from AP 102 having information regarding the location of the various STAs 104 within coverage area 108. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs).

Some types of STAs 104 may support automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that can make use of the information, enable automated behavior of machines, or present the information to humans interacting with the program or application. Examples of applications for such devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

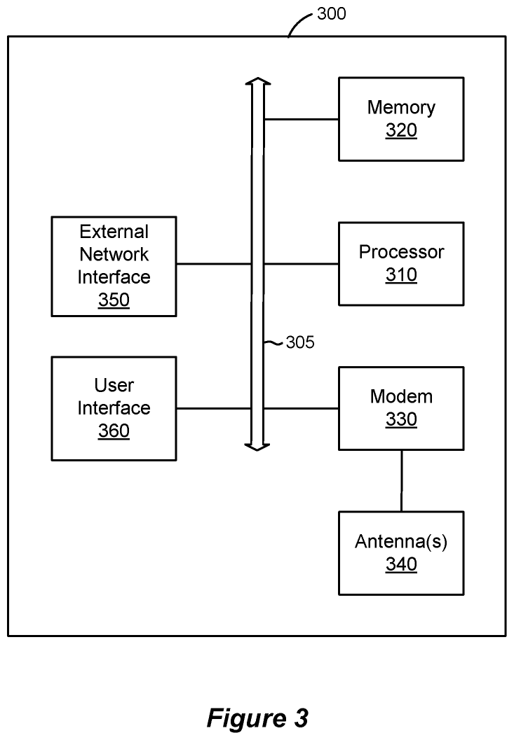

FIG. 3 shows a block diagram of an example access point (AP) 300 for use in wireless communication. For example, the AP 300 may be an example of aspects of the AP 102 described with reference to FIG. 1. The AP 300 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.11ay, 802.11ax, 802.11az, and 802.11ba). The AP 300 includes at least one processor 310 (collectively “the processor 310”), at least one memory 320 (collectively “the memory 320”), at least one modem 330 (collectively “the modem 330”), at least one antenna 340 (collectively “the antenna 340”), at least one external network interface 350 (collectively “the network interface 350”) and, in some instances, a user interface (UI) 360. Each of the components (or “modules”) described with reference to FIG. 3 can communicate with other ones of the components, directly or indirectly, over at least one bus 305.

The processor 310 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 310 processes information received through the modem 330 and the external network interface 350. The processor 310 also can process information to be sent to the modem 330 for transmission through the antenna 340 and information to be sent to the external network interface 350. The processor 310 can generally be configured to perform various operations related to generating and transmitting a downlink frame and receiving an uplink frame.

The memory 320 can include random access memory (RAM) and read-only memory (ROM). The memory 320 also can store processor- or computer-executable software (SW) code containing instructions that, when executed by the processor 310, cause the processor to perform various functions described herein for wireless communication, including generation and transmission of a downlink frame and reception of an uplink frame.

The modem 330 is generally configured to modulate packets and to provide the modulated packets to the antenna 340 for transmission, as well as to demodulate packets received from the antenna 340 to provide demodulated packets. The modem 330 generally includes or is coupled with at least one radio frequency (RF) transmitter and at least one RF receiver, which may be combined into one or more transceivers, and which are in turn coupled to one or more antennas 340. For example, in some AP implementations, the AP 300 can include multiple transmit antennas (each with a corresponding transmit chain) and multiple receive antennas (each with a corresponding receive chain). The modem 330 can communicate bi-directionally, via the antenna 340, with at least one STA (such as the STA 104 described with reference to FIG. 1).

The modem 330 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 310 for processing, evaluation or interpretation, for example, by one or more host applications executing on the processor.

The AP 300 may communicate with a core or backhaul network through the external network interface 350 to gain access to external networks including the Internet. For example, the external network interface 350 may include one or both of a wired (for example, Ethernet) network interface or wireless (for example, LTE, 4G or 5G) network interface.

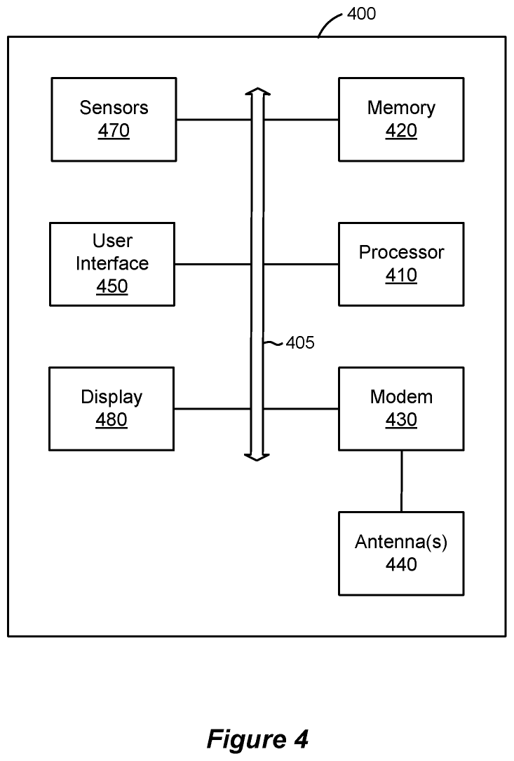

FIG. 4 shows a block diagram of an example wireless station (STA) 400 for use in wireless communication. For example, the STA 400 may be an example of aspects of the STA 104 described with reference to FIG. 1. The STA 400 is capable of transmitting and receiving wireless communications, as well as of encoding and decoding such communications. The wireless communications may conform to any of a number of different wireless communication protocols. For example, the STA 400 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally or alternatively, the STA 400 may be capable of transmitting and receiving Bluetooth packets conforming to a Bluetooth standard, such as defined in IEEE 802.15 or by the Bluetooth SIG. Additionally or alternatively, the STA 400 may be capable of transmitting and receiving wireless packets associated with the Long Term Evolution (LTE), International Mobile Telecommunications-Advanced (IMT-Advanced) 4G or 5G standards.

The STA 400 includes at least one processor 410 (collectively “the processor 410”), at least one memory 420 (collectively “the memory 420”), at least one modem 430 (collectively “the modem 430”) and at least one antenna 440 (collectively “the antenna 440”). In some implementations, the STA 400 additionally includes some or all of the following: a user interface (UI) 450 (such as a touchscreen or keypad), one or more sensors 470 (such as one or more inertial sensors, accelerometers, temperature sensors, pressure sensors, or altitude sensors), and a display 480. Each of the components (or “modules”) described with reference to FIG. 4 can communicate with one another, directly or indirectly, over at least one bus 405.

The processor 410 includes an intelligent hardware device such as, for example, a CPU, a microcontroller, an ASIC or a PLD such as an FPGA, among other possibilities. The processor 410 processes information received through the modem 430 as well as information to be sent to the modem 430 for transmission through the antenna 440. The processor 410 can be configured to perform various operations related to receiving a downlink frame and generating and transmitting an uplink frame.

The memory 420 can include RAM and ROM. The memory 420 also can store processor- or computer-executable SW code containing instructions that, when executed, cause the processor 410 to perform various functions described herein for wireless communication, including reception of a downlink frame and generation and transmission of an uplink frame.

The modem 430 is generally configured to modulate packets and provide the modulated packets to the antenna 440 for transmission, as well as to demodulate packets received from the antenna 440 to provide demodulated packets. The modem 430 generally includes at least one radio frequency (RF) transmitter and at least one RF receiver, which may be combined into one or more transceivers, and which are in turn coupled to one or more antennas 440. For example, in some implementations, the STA 400 can include multiple transmit antennas (each with a corresponding transmit chain) and multiple receive antennas (each with a corresponding receive chain). The modem 430 can communicate bi-directionally, via the antenna 440, with at least one AP (such as the AP 102 described with reference to FIG. 1). As is described above, in some implementations, the modem also can communicate bi-directionally, via the antenna 440, with other STAs directly without the use of an intermediary AP.

The modem 430 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for FQ imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 410 for processing, evaluation or interpretation, for example, by one or more host applications executing on the processor.

As described above, some aspects of WLAN communications can provide for UL multi-user multiple-input, multiple-output (MU-MIMO) techniques can be utilized. These types of communications enables the STAs to send UL data in response to a provocation from an AP, such as a trigger frame.

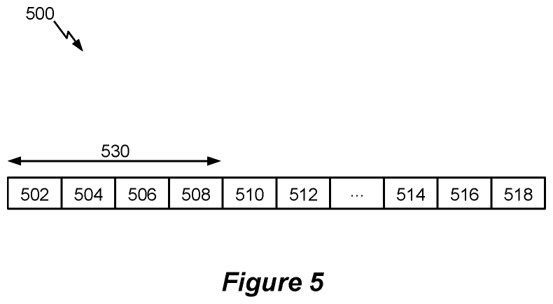

FIG. 5 illustrates one example of the form of a trigger frame 500. For instance, FIG. 5 illustrates that trigger frame 500 can include a frame control 502, a duration 504, a receiving address (RA) 506, and a transmission address (TA) 508, each of which can be included in the MAC header 530. Furthermore, the trigger frame 500 in FIG. 5 can include common information 510, user information 512, user information 514, padding 516, and a frame check sequence (FCS) 518. As shown in FIG. 5, there can be one or more user information blocks between user information 512 and user information 514.

When a trigger frame is sent by an AP, it can solicit a recipient STA(s) to transmit UL Data in response. These responses from the STAs can be a trigger-based (TB) physical layer convergence procedure (PLCP) protocol data unit (PDU), also referred to as TB PPDU. These responses can also include one or more medium access control (MAC) PDUs (MPDUs) that can be aggregated in one or more aggregated MPDUs (A-MPDUs), at least one of the MPDUs including a QoS data frame. Each MPDU can be addressed to the AP transmitting the trigger frame, as well as a virtual AP that is part of the same multi basic service set identifier (BSSID) set as the transmitting AP. The AP can also recommend transmission information to the recipient STA(s), such as which access class (AC) can be used for the QoS data frames and the number of TIDs from which the QoS data frames can be selected from. Some examples of access categories that can be selected are voice, video, background, and best effort. The TIDs can not only act as an identifier of traffic, but they can also identify different block acknowledgement (BlockAck) sessions. For example, by doing so the AP can control the type of data streams, the order of transmissions, or the location from where specific data streams can be sent.

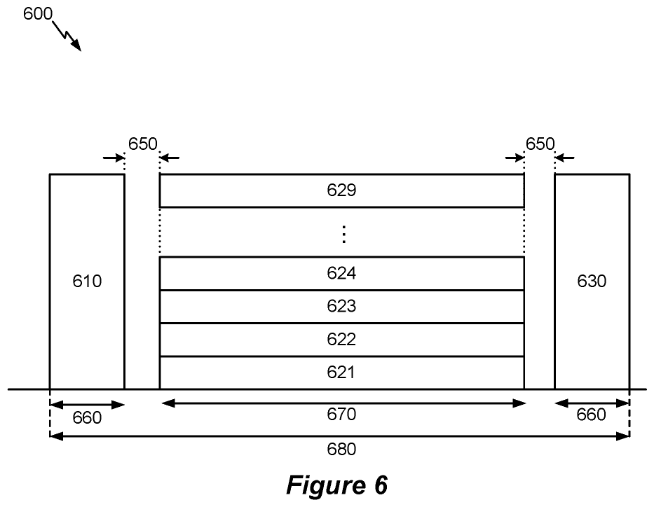

FIG. 6 shows one example of communications 600 between an AP and a number of STAs. For instance, FIG. 6 illustrates an UL multi-user (MU) exchange that is initiated by the AP. In this example, the AP is transmitting the trigger frame 610, in response to which the multiple STAs can each send an TB PPDU, e.g., TB PPDUs 621-629. As noted in FIG. 6, there can be any number of STAs, as denoted by the STA that transmits TB PPDU 621 to the STA that transmits TB PPDU 629. FIG. 6 also displays short interframe space (SIFS) 650 between the trigger frame 610 and the TB PPDUs 621-629, as well as between the TB PPDUs 621-629 and the BlockAck frame 630. Each of the TB PPDUs 621-629 can include one or more MPDUs that can be aggregated in one or more A-MPDUs, at least one of the MPDUs including a QoS data frame or information unit. The TB PPDUs 621-629 can include several different pieces of information, such as a MAC address, sequence numbers (SNs), fragment numbers (FNs), a TID, a TA, and a RA. The RA can include the address of the intended receiver. Each of the QoS data frames or information units can also include an acknowledgement policy which indicates BlockAcks. Upon reception of one or more of the MPDUs, or in some instances without receiving an MPDU, the AP can respond with the multiple STA BlockAck frame 630 that contains the receive status for each of the QoS data frames or information units that were included in the TB PPDU. In some instances, the receive status can be for QoS data frames that were transmitted prior to the latest TB PPDU. FIG. 6 also displays a transmit opportunity 680, which can include downlink transmissions 660 and uplink transmissions 670.

Further, the information frames in each BlockAck can contain one or more BlockAck information fields, each of which can be addressed to the transmitting STAs. Each of these BlockAck information frames can include further information, such as a TID. The BlockAck can solicit acknowledgement from each STA, for example with a simple binary value of zero or one. These acknowledgements can be signaled via the presence of a BlockAck information field addressed to each STA. As noted above, the BlockAck information fields can contain a starting sequence number (SSN), or a BlockAck bitmap that has each bit set to a binary value receive status of the QoS data frame. For example, if the QoS data frame that corresponds to that particular SN, for example SSN or bit location in the bitmap, has been successfully received, the value is set to one. Likewise, if the QoS data frame has not been successfully received, the value is set to zero. The STA receiving the BlockAck information can then determine which of the QoS data frames to retransmit. In most implementations, the QoS data frames selected for retransmission are generally those that have not been received. QoS data frames according to the present disclosure may be referred to as QoS frames or any appropriate phrase.

Various implementations generally relate to identifying data for retransmission in a wireless communication system. Some implementations can more specifically relate to an access point (AP) determining and identifying data to be retransmitted by a station (STA). In some implementations, an AP can transmit a trigger frame to solicit a recipient STA(s) to transmit UL data in response. After receiving the UL data from the STA, the AP can identify and determine the UL data to be retransmitted. In some implementations, the AP can transmit another trigger frame to identify the UL data to be retransmitted by the STA. Some implementations can relate to identifying a specific aspect of UL data from the STA, as well as a specific aspect of data to be retransmitted. For instance, in some implementations, a data response or packet from the STA can include one or more aggregated medium access control (MAC) protocol data unit (A-MPDUs) and one or more MPDUs that can be aggregated in the one or more A-MPDUs, at least one of the MPDUs including one or more QoS frames. In some implementations, when the AP determines and identifies the data to be retransmitted, it can determine at least one QoS frame of the multiple QoS frames to be retransmitted by the STA. The retransmission may be needed when at least a portion of the QoS frame is received as corrupted. In some implementations the AP can determine and identify portions of the QoS frames to be retransmitted (for example only the frame body field of the frame, etc.). In some aspects, when a subsequent trigger frame identifies the UL data to be retransmitted, the at least one QoS frame can be identified. In some implementations, the data response or packet from the STA can include a MAC address, SNs, FNs, or a TID. In some implementations, when the AP determines and identifies the data to be retransmitted, it can be based on based on the MAC address, the one or more SNs, the one or more FNs, or the TID. In some implementations, the A-MPDU can include multiple MPDUs. Further, in some of these instances, each of the QoS frames can transported via one of the MPDUs. In some implementations, the AP can determine a proxy arrangement with another AP. In some of these instances, the other AP can transmit a trigger frame to a STA identifying the data to be retransmitted. In some implementations, the trigger frame from the other AP can identify at least one QoS frame to be retransmitted. In further implementations, the AP can transmit a trigger frame to multiple STAs. In some of these instances, the trigger frame can determine the data to be retransmitted by one of the STAs. In some instances, the data can be retransmitted to the other STA. In some aspects, the AP can also determine one or more information units not to be retransmitted by one of the STAs. In further implementations, the AP and multiple STAs can establish and communicate over a TDLS link.

Particular implementations of the subject matter described in this disclosure can be implemented to realize one or more of the following potential advantages. In some implementations, the described techniques can be used to improve the overall throughput of wireless communication systems. Some implementations according to the present disclosure can be used to maximize the coverage areas of wireless communication systems. Other implementations according to the present disclosure can be used to improve device communication within the wireless system. Yet other implementations according to the present disclosure can help to conserve data resources.

In some implementations according to the present disclosure, the AP transmitting a trigger frame may selectively indicate to the recipient STA(s) some additional information regarding the QoS data frames. For instance, the AP can indicate to the STA that it can include information, for example QoS data frames that were not received, in the follow-up TB PPDU. In some implementations, although the AP may not have control over which MPDUs the STA is going to regenerate, the AP can recommend that the STA include specific information in the TB PPDU. In these instances, the STA can choose the information in the TB PPDU as long as it does not exceed any TID aggregation limits. Additionally, the STA can follow the access configuration of the transmitting frame. In other implementations, the AP can directly instruct the STA include specific information in the TB PPDU. In these instances, the AP can selectively indicate to the STA that it can send a packet of information, for example the specific QoS data frames that were not received.

In some implementations, the transmitting STA may not receive any information from a main AP regarding data retransmission. For example, the main AP may fail to receive any TB PPDU transmitted by the STA, or the trigger frame transmitted by the AP may fail to be received by the STA. In these instances, in order to improve the throughput of communications, multiple APs within the area can help to instruct the transmitting STA regarding data retransmission. Indeed, the transmitting STA can be polled by multiple APs within the area. In some aspects, these multiple APs may have a proxy arrangement with the main AP. For example, the main AP may arrange for the multiple APs to act as a proxy on its behalf in some situations, such as when the main AP fails to receive any data transmitted by the STA, or data transmitted by the AP is not received by the STA. In some instances, these multiple APs acting as a proxy on behalf of the main AP can be referred to as proxy APs.

In instances when the main AP does not receive information from the transmitting STA, the main AP or proxy APs can indicate which MPDUs or data frames may be used during retransmission. As resources or latency may be minimized, it can be beneficial to retransmit information including specific MPDUs or data frames. For example, as discussed previously, the main AP may instruct the STA to retransmit specific MPDUs or data frames that were not received. In this manner, the present disclosure can conserve data resources. By allowing multiple APs to keep track of received data, the present disclosure can improve maintenance of the receive status record. Further, the proxy arrangement of some implementations can allow for multiple avenues of polling or instruction regarding which data may be retransmitted.

In some implementations according to the present disclosure, APs can request that specific information be included in the retransmissions from the STAs. For instance, APs can request that a MAC address be included in the retransmitted data frames from the STAs. Further, the RA of the targeted AP can be included in the retransmitted QoS data frames and TB PPDU. In one implementation of the present disclosure, there can be multiple APs, each of which can have a different RA, and one AP can be trying to communicate with a STA. In these instances, the AP can send a trigger frame requesting to include the RA of the AP. In some implementations, in addition to a MAC address and an RA, APs can request that one or more SNs, fragment numbers, (FNs), or a TID be included in the retransmitted data frames from the STAs. The AP can request that this be a list of SNs or a SSN plus a bitmap, which can be similar to a BlockAck bitmap. Furthermore, the inclusion of the TID can identify the channel or stream for which the selective retransmission is being asked.

As indicated above, if the TB PPDU is not being received by the main AP, then a proxy or auxiliary AP can poll the STA on behalf of the main AP, such that the MAC address or RA of the main AP can be included in the user information field of the polling trigger frame. For example, if a main AP fails to receive one or more data packets, then proxy or auxiliary AP can poll the transmitting STA and ask for the one or more data packets that were not received by the main AP. In one example, up to 64 data packets can be transmitted by a STA, and if one data packet is not received by an AP, then a proxy or auxiliary AP can poll the transmitting STA to retransmit the data packet. In other implementations, a proxy or auxiliary AP within a specific range can receive data packets from an STA on behalf of another AP, as well as send trigger frames on behalf of another AP. Further, one AP can send a BlockAck or a BlockAck bitmap on behalf of another AP. In some implementations, the proxy arrangement can involve the APs being connected to one other. For example, the proxy connection can include a connection channel, a virtual connection, or a cable. In instances of proxy AP polling, the main AP can be idle, and the auxiliary AP can send a BlockAck or trigger frame on behalf of the main AP. Moreover, all the APs within the proxy arrangement can be within a specific range of the STA. By including multiple APs in surrounding areas within a specific range, it can increase the transmission flexibility of the wireless system.

As indicated in accordance with FIG. 5 above, multiple pieces of information can be requested in trigger frames according to the present disclosure. Indeed, trigger frames disclosed herein can request the retransmission of a MAC address, an RA, a TA, one or more SNs, one or more FNs, user information, or TID. In some implementations, a proxy or auxiliary AP can transmit a trigger frame with a TA field that corresponds to the main AP that failed to receive the data packets from the STA. Also, a proxy or auxiliary AP can transmit a trigger frame with a RA of the main AP as indicated in the previously unreceived data packets or frames. Accordingly, the proxy or auxiliary AP can act on behalf of the main AP, as the proxy or auxiliary AP is receiving the data packets from the STA, but the main AP is not. Additionally, in some implementations, upon receiving of the QoS data frames from the STA, the proxy or auxiliary AP can forward the data frames to the main AP via the proxy connection. In some instances, the proxy connection can be a backhaul link or connection, a secondary channel, or another wireless communication channel connecting the main AP to the proxy or auxiliary AP.

The aforementioned trigger frames can use different values within trigger fields. For example, some trigger frames can use a value of the trigger type field in the common information field. Other implementations of trigger fields can use different fields to indicate a particular functionality. As described herein, trigger frames according to the present disclosure that request the retransmission of data from a STA can be referred to as selective retransmission (SR) trigger frames or second trigger frames. The initial trigger frames transmitted by the AP can be referred to as the first trigger frames or initial trigger frames. Further, the functionality of trigger frames herein can be described as a selective solicitation of retransmission within a multiple AP setting. These alternate descriptions can indicate that the proxy or auxiliary APs can specify to the STA the portions of the data frames that can be retransmitted. Also, while the present disclosure herein refers to trigger frames, the frames that request the retransmission of data can be referred to in a number of different manners, such as control frames or any other type of frame.

In one implementation of the present disclosure, an AP can have multiple STAs associated with it and enable the STA transmissions by transmitting trigger frames. Alternatively, the STAs can enable their own transmission by using a type of enhanced distributed channel access (EDCA). In some instances, the types of trigger frames can be referred to as a basic trigger frame, so these implementations can be referred to as a basic service set (BSS) or as a multiple BSS. As described above in addition to multiple STAs, a main AP can have multiple proxy or auxiliary APs associated with it, which can also be referred to as virtual APs. Further, the AP can have multiple TID sessions with each STA associated with it, and each STA can transmit QoS data frames from any of the available communication streams. Because the AP can determine the resource allocation, such as in a second or SR trigger frame, then the STA can transmit QoS data frames including TIDs, SNs, FNs, TAs, RAs, or MAC addresses as solicited by the AP. As indicated herein, in a proxy arrangement, the RAs can indicate the proxy, auxiliary, or virtual APs. A main AP can set up a multiple BSS operation, including one TA and multiple APs, which can contain multiple MAC addresses for the multiple proxy or auxiliary APs. By doing so, the main AP can maximize and target the precise data frames that are not being received.

In some aspects, the AP can determine which of the TID, SN, FN, or RA is the best option to identify the previously failed transmission(s) from the STA. This can be a good way to identify the fails transmissions because the previous transmission(s) from the STA can be contained in an A-MPDU that can have the same TID, SN, FN, or RA. Indeed, the TID/SN/RA information can be contained in the previously failed transmissions. The AP can additionally obtain information by checking an MPDU delimiter that precedes the previous QoS data frame that was not received. In some aspects, if the cyclic redundancy code (CRC) passes for the MPDU delimiter that precedes the failed QoS data frame, the AP can obtain the length of the QoS data frame from the length field of the MPDU delimiter. In this manner, the AP can precisely inform the STA the length of the TB PPDU that can be retransmitted.

The AP can obtain the additional information, such as the TID, RA, MAC address, FN, or SN, in a variety of manners. For example, the AP can investigate the MAC header contents of the QoS data frames. Because the MPDU delimiter can be correct, and the MAC header is short compared to the payload information (for example, 30 bytes compared to hundreds or thousands of bytes), the likelihood of the MAC header being incorrect can be low. Further, the likelihood that the MAC header is incorrect can be reduced as many fields in the MAC header can have values that are understood by the receiver. For example, in the MAC header, there are some fields that can expected to be a specific value, so if these fields are set to the specific value, then the likelihood that the other fields are correct is increased. Also, the frame control has a protocol version field, and if this is set to a specific value, for example zero, then it is a good indication that at least some of the fields in the MAC header are correct, so the STA can confirm if these fields are correct. Further, if some fields are is correct, such as the duration identification, but some fields are missing, then the STA can determine the other fields. As the RA and TA are in the MAC header, the STA can also confirm the RA and TA. As indicated herein, once the STA confirms the information in the MAC header, it can determine the RA, TID, FN, or SN. In other implementations, the RA, TID, FN, or SN can actually be added in the MPDU delimiter itself. As indicated previously, once the AP determines which QoS data frames to resolicit from a STA, it can send an SR trigger frame to the STA that requests the retransmission of QoS data frames with the identified SNs, FNs, TIDs, or RAs. Additionally, the proxy or virtual AP concept can be assigned to the BSS applications described herein. For example, if there are multiple APs in a specific area, then a main AP can be determined and one or more virtual APs can be assigned.

As indicated herein, APs according to the present disclosure can transmit BlockAcks to multiple STAs. In some implementations, the BlockAck can include the receive status for each of the QoS data frames. In other implementations, BlockAck can ask for the recipient to specify the receive status of the QoS data frames. As indicated herein, SR trigger frames transmitted by APs herein can poll STAs for a particular QoS data frame. In some implementations, SR trigger frames can poll STAs for the QoS data frame that is identified by a particular piece of information, such as a SN, FN, TID, RA, or TA.

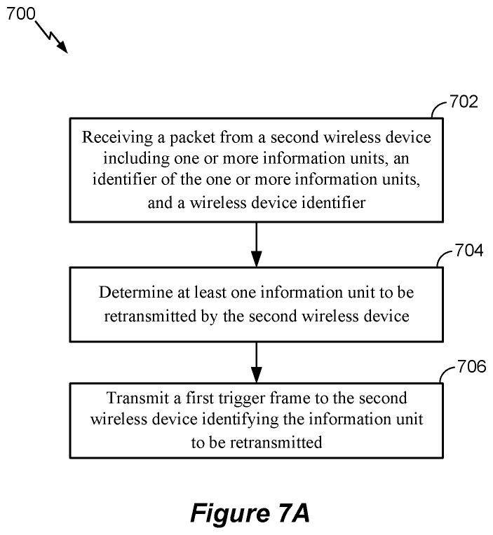

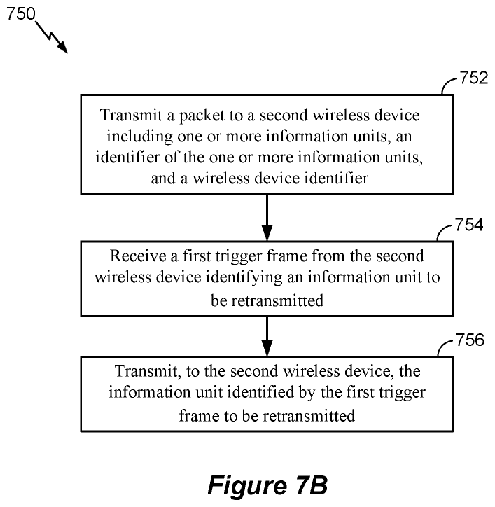

FIG. 7A shows a flowchart illustrating an example process 700 for data retransmission according to some implementations. In some implementations, the process 700 may be performed by a first wireless device such as one of the APs 102 or the STAs 104 and 400 described above with reference to FIGS. 1 and 4, respectively. In some implementations, the process 700 begins in block 702 receiving a packet from at least one second wireless device including one or more information units, e.g., one or more MPDUs wherein each MPDU can be a QoS frame. The packet can include at least one wireless device identifier, e.g., a MAC address, and at least one identifier of the information units, e.g., a SN, a FN, or a TID. In block 704, the process 700 proceeds with determining, based on the at least one wireless device identifier and at least one identifier of the information units, at least one of the one or more information units, e.g., a QoS frame, to be retransmitted by the at least one second wireless device. In block 706, the process 700 proceeds with transmitting a first trigger frame to the at least one second wireless device that identifies the at least one information unit to be retransmitted.

In some implementations, the process 700 can include transmitting a second trigger frame to the one or more second wireless devices prior to receiving the packet and transmitting the first trigger frame, the packet being received from the at least one second wireless device in response to the second trigger frame. In some implementations, the at least one wireless device identifier, e.g., a MAC address, can include a RA of the first wireless device and a TA of the at least one second wireless device, and determining the at least one information unit can be further based on the TA. Also, the packet received in block 702 can include one or more information units that can be aggregated in one or more A-MPDUs, such that at least one of the MPDUs can include the one or more information units. The packet can also include a TB PPDU that includes the at least one A-MPDU. Also, the one or more information units can correspond to one or more MPDUs, and the at least one identifier of the information units can be at least one of a SN, a FN, or a TID.

In some implementations, first wireless device can receive the at least one information unit retransmitted from the at least one second wireless device. Also, in some implementations, transmitting the second trigger frame to the second wireless devices can include broadcasting the second trigger frame to the second wireless devices. In further implementations, transmitting the first trigger frame to the at least one second wireless device can include broadcasting the first trigger frame to the second wireless devices. In some implementations the first trigger frame may be transmitted in a frequency that is different from the frequency used for transmitting the second trigger frame. Also, the first trigger frame may be transmitted by another entity of the first wireless device that is spatially separated from the entity that transmitted the second trigger frame. The first trigger frame and second trigger frame can be communicated to the second wireless devices in a variety of manners.

In some implementations, the first trigger frame can include the SN, or a combination of a starting SN (SSN) and a bitmap.

In some implementations, the packet can include an MPDU delimiter, and determining the at least one information unit to be retransmitted by the at least one second wireless device can include determining a length of the at least one information unit to be retransmitted by the at least one second wireless device based on information contained in the MPDU delimiter. Also, in some aspects, the length of the at least one information unit can be determined if the MPDU delimiter passes a cyclic redundancy check (CRC). In some implementations, a MAC header of the one or more information units or the MPDU delimiter can include the at least one identifier of the information units, a TA, or a RA of the first wireless device.

In some implementations, a signal field of a physical layer (PHY) preamble can include at least a portion of the at least one identifier of the information units, a RA of the first wireless device, or a TA of the at least one second wireless device.

In some implementations, the process 700 can include determining a proxy arrangement with at least one proxy wireless device. In some implementations, the at least one information unit retransmitted from the at least one second wireless device can be received by the at least one proxy wireless device based on the proxy arrangement, and the process 700 can further include receiving, from the at least one proxy wireless device, the at least one information unit retransmitted from the at least one second wireless device. The first trigger frame can also be transmitted by the at least one proxy wireless device after the first wireless device generates an ACK to an TB PPDU, wherein the TB PPDU can be transmitted by the one or more second wireless devices in response to the second trigger frame, wherein the first trigger frame can be orthogonally multiplexed in frequency. The first trigger frame can also be transmitted by the at least one proxy wireless device and include a TA of the first wireless device. Further, the at least one information unit retransmitted from the at least one second wireless device can comprise a RA of the at least one proxy wireless device.

In some implementations, the process 700 can include establishing a TDLS link with the at least one second wireless device and at least one peer wireless device. In some implementations, the first trigger frame can be transmitted over the TDLS link. In further aspects, the process 700 can include receiving the at least one information unit retransmitted from the at least one second wireless device over the TDLS link. The at least one information unit retransmitted from the at least one second wireless device can also include a RA of the at least one peer wireless device. In some implementations, the process 700 can include transmitting, to the at least one peer wireless device, the at least one information unit retransmitted from the at least one second wireless device. In some implementations, the process 700 can include transmitting at least one ACK frame to the at least one second wireless device or the at least one peer wireless device over the TDLS link.

As indicated herein, some implementations according to the present disclosure can include a TDLS including multiple wireless devices or STAs, for example two STAs, both of which can be associated with a wireless device or AP. Based on the TDLS, the multiple STAs can exchange data with each other without the intervention of the AP. In some instances, once the TDLS is setup between the two STAs, the AP may not participate in the communication exchanges between the two STAs. As the AP can be within a specific range of both STAs, and the AP may help in connecting the TDLS link or improving the achievable throughput between the two STAs. In order to do so, the AP can poll one of the TDLS STAs to retransmit data that may be intended for the other TDLS STA. As discussed above, the AP can send a trigger frame to one or both of the STAs that can enable the STAs to better communicate with each other. As such, the AP can be within a specific range of the STAs.

In some aspects, the AP can receive the retransmitted data from one TDLS STA and subsequently forward the data to the TDLS peer STA. In these implementations, the AP can relay communication from one TDLS STA to the other by receiving the data packet from the one STA and sending it to the other STA. In other aspects, the AP can request one TDLS STA to retransmit the data directly to the TDLS peer STA. In each of these instances, the AP can improve the throughput of the TDLS STAs. The AP can also improve the throughput of the network, as the STAs can use the same frequency as other devices within the network. In some instances, the AP can have a higher transmit power than the STAs, so the AP can instruct the STAs to transmit over a narrower bandwidth. This can help to optimize the resources of the network.

In some implementations, the presence of the MAC address, SNs, and RAs can be beneficial when the AP can receive at least some of the information units from the initial transmission in the TDLS link. In these instances, the AP can receive the data packets or frames from one STA and then sends them to the other STA. In instances when the AP does not receive all of the data packets or frames, the AP can poll a TDLS STA, such as by sending an SR trigger frame or BlockAck, to retransmit the SNs that it has not received successfully. In response to the SR trigger frame, the TDLS STA can retransmit the solicited information units. The TDLS STA can also use any BlockAck it receives from the AP to update its BlockAck state. Additionally, the AP can determine which of the information units the TDLS peer STA has not been able to receive from the BlockAck or ACK the TDLS peer STA transmits in response to the information units. In some implementations, the AP can deliver the data frames or information units it successfully receives from the TDLS STA to the TDLS peer STA. As indicated above, the AP can send the information units which were not yet received by the TDLS peer STA in a subsequent exchange. In some instances, the AP can amplify the transmitted data. In some instances, the numbers can indicate the location of the data frames in a time-sequence.

FIG. 7B shows a flowchart illustrating an example process 750 for data retransmission according to some implementations. In some implementations, the process 750 may be performed by a first wireless device such as one of the APs 102 or the STAs 104 and 400 described above with reference to FIGS. 1 and 4, respectively. In some implementations, the process 750 begins in block 752 with transmitting a packet to a second wireless device, the packet including one or more information units, at least one identifier of the information units, and at least one wireless device identifier. In block 754, the process 750 proceeds with receiving a first trigger frame from the second wireless device, the first trigger frame identifying at least one information unit to be retransmitted. In block 756, the process 750 proceeds with transmitting, to the second wireless device, the at least one information unit identified by the first trigger frame to be retransmitted.

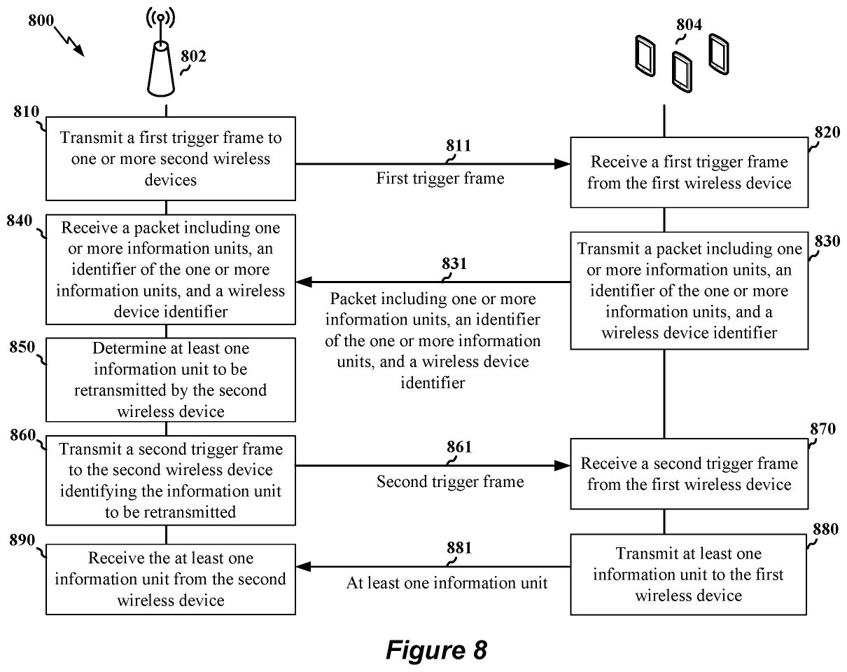

FIG. 8 shows a timing diagram illustrating the transmissions of communication 800 in the example processes of FIGS. 7A and 7B. In some implementations, the communication 800 may be performed by a first wireless device or AP 802 and one or more second wireless devices or STAs 804. In some implementations, the communication 800 begins in block 810 with transmitting a first trigger frame 811 from the first wireless device or AP 802 to the one or more second wireless devices or STAs 804. In block 820, the communication 800 proceeds with receiving a first trigger frame 811 at the second wireless devices or STAs 804. In block 830, the communication 800 proceeds with transmitting a packet 831 from at least one second wireless device or STA including one or more information units, e.g., one or more MPDUs that include a QoS frame. The packet 831 can include at least one wireless device identifier, e.g., a MAC address, and at least one identifier of the information units, e.g., a SN, a FN, or a TID. In block 840, the communication 800 proceeds with receiving the packet 831 from the second wireless device or STAs 804 at the first wireless device or AP 802. In block 850, the communication 800 proceeds with determining, based on the at least one wireless device identifier and the at least one identifier of the information units, at least one of the one or more information units, e.g., a QoS frame, to be retransmitted by the at least one second wireless device or STA 804. In block 860, the communication 800 proceeds with transmitting a second trigger frame 861 to the at least one second wireless device or STA 804 identifying the at least one information unit to be retransmitted. In block 870, the communication 800 proceeds with receiving the second trigger frame 861 from the first wireless device or AP 802 identifying the at least one information unit to be retransmitted. In block 880, the communication 800 proceeds with transmitting the at least one information unit 881 that is retransmitted from the second wireless device or STA 804. In block 890, the communication 800 proceeds with receiving the at least one information unit 881 at the first wireless device or AP 802 that is retransmitted from the second wireless device or STA 804.

In some implementations, the wireless communication systems described above can be used in other settings. For example, wireless communication systems herein can be used in a multiple band setting, where the AP and the STA are operating in dual band mode. In these instances, each AP in a frequency band can have its own RA. Some example of frequency bands in the multiple band setting are 2.4, 5, or 6 GHz. The AP can also solicit selective retransmission in the alternate band from the STA when the main band is suffering heavy interference, or is not allowed to be accessed.

Additionally, wireless communication systems herein can be used in a multiple AP or mesh setting. In these instances, there can be multiple APs that can cooperate with each other. For example, if one of the APs fails to receive any QoS data frames sent by a ST, a nearby AP that has received the QoS data frames can resolicit the frames that were not received by the AP. In some implementations, if the APs are connected via a backhaul connected then the QoS data frames can be delivered via the backhaul. In other implementations, the nearby AP can distribute the data to the AP in a subsequent transmission. In some implementations, the multiple AP and multiple band functionalities can be used together.

In some implementations, the transmitted data may not be encrypted. For example, the man in the middle (MIM) may not decrypt the QoS data frames, and only forward the data packets that have been indicated as failed by the recipient. Also, if the recipient has received them successfully in the first place, then it will simply discard the retransmitted one. For example, even if an AP is acting maliciously, because the APs only forward the data packets without encryption, then the communication system may not be compromised. If an AP tries to corrupt a data packet, then it can be captured and receive a failure message.

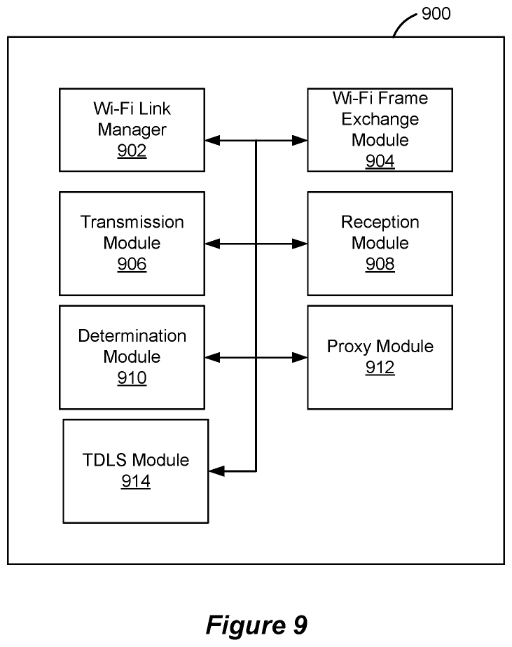

FIG. 9 shows a block diagram of an example wireless communication device 900 for use in wireless communication according to some implementations. In some implementations, the wireless communication device 900 can be an example of the AP 102 or STAs 104 and 400 described above with reference to FIGS. 1 and 4, respectively. In some implementations, the wireless communication device 900 is configured to perform the processes 700 and 750 described above with reference to FIGS. 7A and 7B, respectively. The wireless communication device 900 includes a Wi-Fi link manager 902, a Wi-Fi frame exchange module 904, a transmission module 906, a reception module 908, a determination module 910, a proxy module 912, and a TDLS module 914. Portions of one or more of the modules 902, 904, 906, 908, 910, 912, and 914 may be implemented at least in part in hardware or firmware. For example, the Wi-Fi frame exchange module 904 may be implemented at least in part by one or more modems (for example, a Wi-Fi (IEEE 802.11) modem). In some implementations, at least some of the modules 902, 904, 906, 908, 910, 912, and 914 are implemented at least in part as software stored in a memory (such as the memory 420). For example, portions of one or more of the modules 902, 904, 906, 908, 910, 912, and 914 can be implemented as non-transitory instructions (or “code”) executable by at least one processor (such as the processor 410) to perform the functions or operations of the respective module. In some implementations, the wireless communication device 900 further includes a local database 916.

The Wi-Fi link manager 902 is configured to manage the creation, maintenance and termination of one or more Wi-Fi links in accordance with the IEEE 802.11 family of standards (such as that defined by the IEEE 802.11-2016 specification or amendments thereof). For example, the Wi-Fi link manager 902 is configured to perform passive or active scanning operations (“scans”) on one or more frequency bands (for example, the 2.4 GHz, 5 GHz, 6 GHz or 60 GHz bands), for example, by listening for beacons (passive scanning) or by generating probe requests and receiving probe responses via a transceiver (active scanning). The Wi-Fi link manager 902 is configured to establish Wi-Fi links with various other devices such as APs and STAs including other wireless communication devices.

For example, the Wi-Fi link manager 902 is configured to perform authentication and association operations to establish a BSS link with a selected AP as a client of the AP. In some implementations, the wireless communication device 900 further includes SoftAP functionality. In such implementations, the Wi-Fi link manager 902 is further configured to perform authentication and association operations to establish BSS links with various client devices to provide access point services as a Wi-Fi hotspot to the client devices. In some implementations, the Wi-Fi link manager 902 is further configured to establish P2P links with various other wireless communication devices such as a number of peer wireless communication devices 900. For example, the Wi-Fi link manager 902 is configured to perform discovery, authentication, and synchronization operations to join a P2P network group, such as a NAN cluster, and establish P2P links, such as NAN links, with the peer devices.

The Wi-Fi link manager 902 is further configured to monitor a status of each operational Wi-Fi link (including BSS and P2P links), for example, by monitoring the links for beacons or particular types of packets. The Wi-Fi link manager 902 is further configured to disable Wi-Fi links, including BSS and P2P links, responsive to various criteria including signal quality metrics or user input.

The Wi-Fi frame exchange module 904 is configured to generate, receive and perform the initial processing of frames implemented via at least one of the IEEE 802.11 family of standards (such as that defined by the IEEE 802.11-2016 specification or amendments thereof). For example, the Wi-Fi frame exchange module 904 is configured to generate, receive and process Wi-Fi frames such as management frames (for example, beacon frames, probe request/response frames, and association request/response frames), control frames (for example, Request to Send (RTS) frames, Clear to Send (CTS) frames, and acknowledgement (ACK) frames), data frames, and trigger frames to be transmitted to, or received from, an AP or a STA via a modem. For example, the Wi-Fi frame exchange module 904 may relay external network communications received from an AP to one or more client devices. Similarly, the Wi-Fi frame exchange module 904 may relay network communications received from one or more client devices to an AP for transmission to one or more external networks. The Wi-Fi frame exchange module 904 also may generate, receive and process communications such as NAN communications including discovery beacons, synchronization beacons, publish and subscribe messages, paging messages and data frames.

The transmission module 906 can be configured to transmit a first trigger frame from a first wireless device or AP to one or more second wireless devices or STAs. For example, in some implementations, the transmission module 906 can transmit a first trigger frame to a single second wireless device or STA. In other implementations, the transmission module 906 can transmit a first trigger frame to one or more second wireless devices or STAs. In some implementations, transmitting the first trigger frame can further include broadcasting the first trigger frame. In further implementations, transmitting the second trigger frame to the one or more second wireless devices can include broadcasting the second trigger frame to the second wireless devices. In some implementations the second trigger frame may be transmitted in a frequency that is different from the frequency used for transmitting the first trigger frame. Also, the second trigger frame may be transmitted by another entity of the first wireless device that is spatially separated from the entity that transmitted the first trigger frame. In some implementations, the transmission module 906 can transmit a second trigger frame from a first wireless device or AP to one or more second wireless devices or STAs. The second trigger frame can identify at least one information unit, e.g., a QoS frame, to be retransmitted from the second wireless devices or STAs.

The reception module 908 can be configured to receive a packet from a second wireless device or STA. The packet can include one or more information units, e.g., MPDUs including a QoS frame, as well as include at least one wireless device identifier, e.g., a MAC address, and at least one identifier of the information units, e.g., a SN, a FN, or a TID. Additionally, the packet can include one or more A-MPDUs, such that the one or more information units, e.g., MPDUs, can be aggregated in the one or more A-MPDUs. Also, the packet can include a TB PPDU that includes the A-MPDUs. Further, the reception module 908 can be configured to receive the packet from one or more second wireless devices or STAs. The packet can also include a RA of the first wireless device or AP and a TA of the at least one second wireless device. In some implementations, the reception module 908 can receive the at least one information unit, e.g., QoS frame, that is retransmitted from the at least one second wireless device or STA.

The determination module 910 can be configured to determine, based on the at least one wireless device identifier, e.g., MAC address, and the at least one identifier of the information units, e.g., the SN, the FN, or the TID, at least one information unit to be retransmitted by the at least one second wireless device or STA. The packet can include an MPDU delimiter. In some implementations, determining at least one information unit to be retransmitted by the at least one second wireless device can include determining a length of the at least one information unit to be retransmitted by the at least one second wireless device based on information contained in the MPDU delimiter. Further, the length of the at least one information unit can be determined if the MPDU delimiter passes a cyclic redundancy check (CRC). Also, a MAC header of the one or more information units or the MPDU delimiter can include the at least one identifier of the information units, e.g., the SN, the FN, the TID, a TA, or a receiver address (RA) of the first wireless device. Moreover, a signal field of a physical layer (PHY) preamble can include at least a portion of the at least one identifier of the information units, a RA of the first wireless device, or a TA of the at least one second wireless device.

The proxy module 912 can be configured to determine a proxy arrangement between the first wireless device or AP and at least one proxy wireless device or AP. The second trigger frame can be transmitted by the at least one proxy wireless device or AP based on the proxy arrangement configured by the proxy module 912. The at least one proxy AP can also receive the at least one information unit, e.g., QoS frame, that is retransmitted from the second wireless device or STA based on the proxy arrangement configured by the proxy module 912. Moreover, the second trigger frame can be transmitted by the at least one proxy wireless device and include a TA of the first wireless device or AP. Additionally, the at least one information unit, e.g., QoS frame, retransmitted from the at least one second wireless device or STA can include a RA of the at least one proxy wireless device or AP.

The TDLS module 914 can be configured to arrange a TDLS relationship between the at least one second wireless device or STA and at least one peer wireless device or STA. The TDLS module 914 can also establish a TDLS link between the at least one second wireless device or STA and at least one peer wireless device or STA. The at least one second wireless device or STA and at least one peer wireless device or STA can also communicate based on the TDLS link configured by the TDLS module 914. Also, the second trigger frame can be transmitted over the TDLS link. The TDLS module 914 can also be configured to receive the at least one information unit, e.g., QoS frame, retransmitted from the at least one second wireless device or STA over the TDLS link. The at least one QoS frame retransmitted from the at least one second wireless device or STA can include a RA of the at least one peer wireless device or STA. The TDLS module 914 can further be configured to transmit, to the at least one peer wireless device or STA, the at least one information unit, e.g., QoS frame, retransmitted from the at least one second wireless device or STA. The TDLS module 914 can also be configured to transmit at least one ACK frame to the at least one second wireless device or STA or the at least one peer wireless device or STA over the TDLS link.

The local database 916 may be stored with each of the modules 902, 904, 906, 908, 910, 912, and 914 in a memory (such as the memory 420). In some other implementations, the local database 916 is stored in or implemented by another memory or memory device logically or physically separate from the memory used to store each of the modules 902, 904, 906, 908, 910, 912, and 914. In various implementations, the local database 916 stores profile information for various other wireless communication devices including STAs as well as APs. For example, in implementations in which the wireless communication device 900 is a STA, the local database 916 can store profile information for each AP the wireless communication device 900 is or has been associated with, as well as profile information for one or more APs it has not previously associated with. The profile information may include any of the scanning information obtained through passive or active scans as well as information obtained through communications received from the AP or from peer devices. For example, the profile information can include, for each identified AP, a respective SSID, a respective MAC address, a respective IP address, a number of capabilities or capability requirements, supported data rates, one or more parameters associated with the respective wireless network, a connection history with the AP, a geographic location of the AP, channel state information (CSI), RSSI values, primary and secondary frequency channels on which the AP is currently operating or previously operated, other scanning information, or any other suitable information.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a first wireless device, comprising:
receiving a packet from at least one second wireless device, the packet including one or more information units, at least one identifier of the one or more information units, and at least one wireless device identifier;
determining, based on the at least one wireless device identifier and the at least one identifier of the one or more information units, at least one information unit of the one or more information units to be retransmitted by the at least one second wireless device; and
transmitting a first trigger frame to the at least one second wireless device, the first trigger frame identifying the at least one information unit to be retransmitted.

2. The method of claim 1, further comprising transmitting a second trigger frame to the one or more second wireless devices prior to receiving the packet and transmitting the first trigger frame, the packet being received from the at least one second wireless device in response to the second trigger frame.

3. The method of claim 1, wherein the at least one wireless device identifier includes at least one of a receiver address (RA) of the first wireless device or a transmitter address (TA) of the at least one second wireless device, wherein determining the at least one information unit to be retransmitted is based on at least one of the TA or the RA.

4. The method of claim 1, wherein the one or more information units correspond to one or more medium access control (MAC) protocol data units (MPDUs), and the at least one identifier of the one or more information units includes at least one of a sequence number (SN), a fragment number (FN), or a traffic identifier (TID).

5. The method of claim 4, wherein the first trigger frame includes the SN, or a combination of a starting SN (SSN) and a bitmap of SNs for the at least one second wireless device to retransmit the at least one information unit.

6. The method of claim 1, wherein the packet includes at least one aggregated MPDU (A-MPDU) including the one or more information units.

7. The method of claim 6, wherein the packet includes a trigger-based (TB) physical layer convergence procedure (PLCP) protocol data unit (PPDU) that includes the at least one A-MPDU.

8. The method of claim 1, further comprising receiving the at least one information unit retransmitted from the at least one second wireless device.

9. The method of claim 2, wherein transmitting the second trigger frame to the one or more second wireless devices includes broadcasting the second trigger frame.

10. The method of claim 9, wherein transmitting the first trigger frame to the at least one second wireless device includes broadcasting the first trigger frame to the at least one second wireless device.

11. The method of claim 1, wherein the packet includes at least one MPDU delimiter that precedes the at least one information unit, wherein determining the at least one information unit to be retransmitted comprises determining a length of the at least one information unit to be retransmitted by the at least one second wireless device based on information contained in the MPDU delimiter.

12. The method of claim 11, wherein determining the at least one information unit to be retransmitted comprises determining the length of the at least one information unit to be retransmitted if the MPDU delimiter passes a cyclic redundancy check (CRC).

13. The method of claim 11, wherein the packet includes a plurality of MPDUs that contain the one or more information units, the packet further including a MAC header and an MPDU delimiter for each of the plurality of MPDUs, wherein at least one of the MAC headers or at least one of the MAC delimiters includes the at least one identifier of the one or more information units and the at least one wireless device identifier.

14. The method of claim 1, wherein the packet includes a physical layer (PHY) preamble, the PHY preamble including a signal field that includes at least a portion of the at least one identifier of the one or more information units and the at least one wireless device identifier.

15. The method of claim 1, further comprising determining a proxy arrangement with at least one proxy wireless device.

16. The method of claim 15, wherein the at least one information unit retransmitted from the at least one second wireless device is received by the at least one proxy wireless device based on the proxy arrangement, the method further comprising receiving, from the at least one proxy wireless device, the at least one information unit retransmitted from the at least one second wireless device.

17. The method of claim 1, further comprising establishing a tunneled direct link setup (TDLS) link between the at least one second wireless device and at least one peer wireless device.

18. The method of claim 17, wherein the first trigger frame is transmitted to solicit the at least one second wireless device to retransmit the at least one information unit over the TDLS link with the at least one peer wireless device.

19. The method of claim 17, further comprising receiving the at least one information unit retransmitted from the at least one second wireless device over the TDLS link.

20. The method of claim 19, wherein the at least one information unit retransmitted from the at least one second wireless device comprises a receiver address (RA) of the at least one peer wireless device.

21. The method of claim 19, further comprising transmitting, to the at least one peer wireless device, the at least one information unit retransmitted from the at least one second wireless device.

22. The method of claim 17, further comprising transmitting at least one acknowledgement (ACK) frame or block ACK (BlockAck) frame to the at least one second wireless device or the at least one peer wireless device over the TDLS link upon reception of the at least one information unit.

23. The method of claim 1, further comprising refraining from transmitting at least one ACK frame or BlockAck frame for the packet based on transmitting the first trigger frame.

24. A method for wireless communication by a first wireless device, comprising:
transmitting a packet to a second wireless device, the packet including one or more information units, at least one identifier of the information units, and at least one wireless device identifier;
receiving a first trigger frame from the second wireless device, the first trigger frame identifying at least one information unit of the one or more information units to be retransmitted; and
transmitting, to the second wireless device, the at least one information unit identified by the first trigger frame to be retransmitted.

25. The method of claim 24, further comprising receiving a second trigger frame from the second wireless device prior to transmitting the packet and receiving the first trigger frame, the packet being transmitted in response to the second trigger frame.

26. The method of claim 24, wherein the at least one wireless device identifier includes a receiver address (RA) of the second wireless device or a transmitter address (TA) of the first wireless device.

27. The method of claim 24, wherein the one or more information units correspond to one or more medium access control (MAC) protocol data units (MPDUs), and the at least one identifier of the information units is at least one of a sequence number (SN), a fragment number (FN), or a traffic identifier (TID), wherein the first trigger frame includes the SN, or a combination of a starting SN (SSN) and a bitmap of SNs for the first wireless device to transmit the at least one information unit.

28. The method of claim 24, wherein the packet includes at least one aggregated MPDU (A-MPDU) including the one or more information units.

29. A wireless communication device at a first wireless device comprising:
at least one processor; and
at least one memory communicatively coupled with the at least one processor and storing processor-readable code that, when executed by the at least one processor, causes the wireless communication device to:
receive a packet from at least one second wireless device, the packet including one or more information units, at least one identifier of the one or more information units, and at least one wireless device identifier;
determine, based on the at least one wireless device identifier and the at least one identifier of the one or more information units, at least one information unit of the one or more information units to be retransmitted by the at least one second wireless device; and
transmit a first trigger frame to the at least one second wireless device, the first trigger frame identifying the at least one information unit to be retransmitted.

30. A wireless communication device at a first wireless device comprising:
at least one processor; and
at least one memory communicatively coupled with the at least one processor and storing processor-readable code that, when executed by the at least one processor, causes the wireless communication device to:
transmit a packet to a second wireless device, the packet including one or more information units, at least one identifier of the information units, and at least one wireless device identifier;
receive a first trigger frame from the second wireless device, the first trigger frame identifying at least one information unit of the one or more information units to be retransmitted; and
transmit, to the second wireless device, the at least one information unit identified by the first trigger frame to be retransmitted.
